(19) United States
(12) Patent Application Publication
(10) Pub. No.: US 2012/0296852 A1
(43) Pub. Date: Nov. 22, 2012

(54) DETERMINING WORKLOAD COST

(76) Inventors: Daniel Juergen Gmach, Palo Alto, CA (US); Jerome Rolia, Kanata (CA); Ludmila Cherkasova, Sunnyvale, CA (US)

(21) Appl. No.: 13/112,677

(22) Filed: May 20, 2011

(51) Int. Cl. G06F 17/00

(52) U.S. Cl. 705/400

(57) ABSTRACT

A method of determining a workload cost is provided herein. The method includes determining a direct consumption of a resource pool by a workload. The method also includes determining a burstiness for the workload and the resource pool. The burstiness comprises a difference between a peak consumption of the resource pool by the workload, and the direct consumption of the resource pool. The method further includes determining an unallocated amount of the resource pool. Additionally, the method includes determining the workload cost based on the direct consumption, the burstiness, and the unallocated amount of the resource pool.

### BACKGROUND

Virtualization technologies are maturing and the computing capacity of individual servers is increasing rapidly. As a result, more and more computing can be conducted in shared resource pools, such as virtualization and cloud computing. In such environments, it is growing increasingly important to account for shared infrastructure usage. Costs are typically based on the portion of resources used in the shared infrastructure. The method for determining costs is known as costing.

Before the virtualization era, a costing model was generally straightforward. The server hardware, its power usage, and software costs were directly associated with the deployed applications using these resources. Accordingly, storage and networking costs were typically apportioned to an application based on the application's use of the resources. However, the increasing complexity of virtual machines with various resource requirements has increased the complexity of determining costs. Further, workloads may be moved around due to various migration and management processes. The complexity of these infrastructures has made it increasingly challenging to determine costs in a way that is fair to both the workload user and the service provider.

### BRIEF DESCRIPTION OF THE DRAWINGS

Certain exemplary embodiments are described in the following detailed description and in reference to the drawings, in which:

FIG. 1 is a graph representing resource usage of two example workloads in accordance with an embodiment;

FIG. 2 is a process flow diagram showing a method of determining workload cost in accordance with an embodiment;

FIG. 3 is a graph representing workload memory usage in accordance with an embodiment;

FIG. 4 is a graph representing workload CPU usage in accordance with an embodiment;

FIG. 5 is a graph representing costs by server usage in accordance with an embodiment;

FIG. 6 is a graph representing costs by server burst in accordance with an embodiment;

FIG. 7 is a graph representing costs by pool burst usage in accordance with an embodiment;

FIG. 8 is a graph representing CPU and memory costs per workload in accordance with an embodiment;

FIG. 9 is a block diagram of a system for determining workload cost in accordance with an embodiment; and

FIG. 10 is a block diagram showing a non-transitory, computer-readable medium that stores code for determining a workload cost in accordance with an embodiment.

### DETAILED DESCRIPTION

The cost of a workload to a customer or application represents a fair share of the resource usage, not an amount charged to a customer for the workload. Rather, the amount charged to a customer is referred to as the chargeback, which may be based, in part, on the cost. However, the chargeback may also be based on other factors related to marketing the computing resources to the service providers' various customers.

One approach for costing is to extend the usage-based model. For example, by monitoring usage information at the virtualization layer, it is possible to derive average resource usage for each application over a specified monitoring period. Additional physical server costs can then be split up respectively. Currently, many service providers employ such simplified usage-based costing models.

However, the relationship between workloads and costs is actually more complex. For example, some workloads may have a large peak-to-mean ratio for demands upon server resources. A peak-to-mean ratio is a comparison between the maximum, or peak, demand and the mean, or average, demand. Workloads with such high ratios may have a disproportionate share of intense resource use. Peak periods are computationally expensive. As such, the mean use does not fairly represent the cost of such workloads.

Workloads with high peak-to-mean ratios are referred to herein as “bursty.” For example, a workload may have a peak CPU demand of 5 CPU cores but a mean demand of 0.5 of a CPU core. Such ratios may have an impact on shared resource pools. A pool that aims to consistently satisfy the demands of bursty workloads will have to limit the number of workloads assigned to each server. This affects the number of servers needed for a resource pool. As such, bursty workloads drive up costs.

Further, server resources are typically not fully utilized. Even though many services can be assigned to a server, some portion of the resources remain unused over time. The amount of unused resources may depend on workload placement and consolidation, as described herein. To determine costs fairly, unallocated resources may be calculated as a cost that is shared equally across all workloads.

The total costs of a resource pool include acquisition costs for facilities, physical information technology (IT) equipment and software, power costs for operating machines and facilities, and administration costs. Acquisition costs are typically considered with respect to a three year time horizon, and reclaimed according to an assumed rate for each costing interval. However, in one embodiment, costing is limited to server costs and virtualization software licensing costs. A server's costs may be broken down for its resources, such as the CPU and memory. Some server costs, like the CPU and memory, can be mapped directly. Other server costs, such as the power supply, motherboard, or other costs that are not considered directly, may be broken down equally or according to the proportion of the direct assigned costs to the considered resources. In one embodiment, licensing costs may be assigned as CPU or memory costs. In another embodiment, licensing costs may be divided equally across CPU or memory or in proportion to the costs of CPU and memory. In such embodiments, three categories of usage may be tracked for each resource. A resource may include CPU's, memory, etc., for each costing interval. The three categories of resource usage include direct resource consumption by a workload, burstiness, and unallocated resources. All three categories of usage may range from [0,100], representing a percentage of use. Direct resource consumption, d_{s,w}, may represent the average physical utilization of a server, s, by a workload, w. Further, d_{s,w}, is 0 if a workload, w, does not use a server, s. Burstiness, b_{s,w}, may represent the difference between peak utilization of a server, s, by a workload, w, and its average utilization. Additionally, bₛ, may represent the difference between the peak utilization of a server, s, and its average utilization. In another embodiment, b_{s,w}, and bₛ may represent the difference between a high percentile of utilization of a server, s, and an average utilization. Unallocated resources, aₛ, represent the difference between 100% use and the peak utilization for a server s. For clarity, the above notation considers one resource at a time, such as CPU or memory. The corresponding costs over all resources may be summed to give a total cost for each costing interval.

The traditional server-usage approach to costing considers only the direct resource consumption by w workloads. Accordingly, a server, s, has a cost, C_{S}, that includes costs that may be assigned to workloads associated with the server. A workload's server-usage is represented in Equation 1.

$$Π \begin{matrix}server \text{-} usage \\ s , w\end{matrix} = {C}_{S} \frac{{d}_{s , w}}{{\sum }_{{w}^{′} = 1}^{W} {d}_{s , {w}^{′}}} \qquad EQUATION 1$$

Equation 1 represents the workload server usage costs as the server costs multiplied by the direct resource consumption, divided by the sum of direct resource consumption across all workloads. The server-usage approach does not, however, take into account the cost of burstiness.

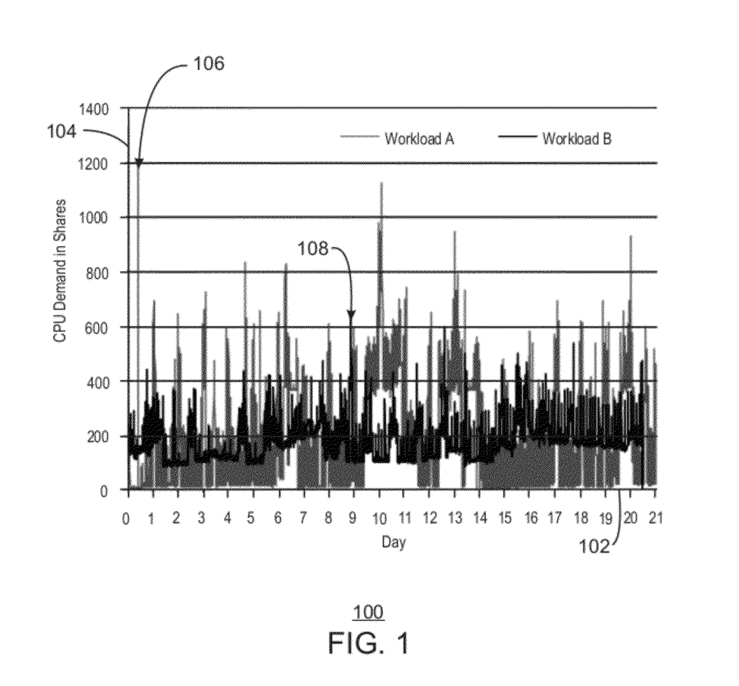

FIG. 1 is a graph 100 representing resource usage of two example workloads A, B, in accordance with an embodiment. The graph 100 includes an x-axis 102 representing each day of a three week costing interval and a y-axis 104 representing CPU demand in shares. The shares represent a share of CPU use. For example, 100 shares may correspond to a single 1 GHz CPU. Both workloads exhibit a similar average CPU demand: 161.8 CPU shares for Workload A, and 170.3 shares for Workload B. However, as shown, Workload A has a much higher variability and much higher peaks than Workload B. Workloads A's peak usage is 1200 CPU shares, as indicated by reference number 106, whereas Workload B's peak is 645 CPU shares, as indicated by reference number 108. The burstiness of Workload A may cause less dense workload placements on its server, and thus a lower average server utilization, and the need for more servers. However, according to Equation 1, the CPU costs for hosting Workload A may only be $36.27, whereas Workload B has costs of $39.12. As such, the server-usage approach does not fairly reflect the true cost of these example workloads to the service provider.

Accordingly, a server-burst approach may be used to determine costs. To account for the costs of burstiness and unallocated resources, the server cost, C_{S}, may be further partitioned into costs associated with the average use of the server, C^{d}ₛ; costs associated with the difference between the peak and average use of the resource, C^{b}ₛ; and costs associated with the difference between the maximum available capacity and the peak use of the resource, C^{a}ₛ. Accordingly, Cₛ=C^{d}ₛ+C^{b}ₛ+C^{a}_{b}.

The bursty portion of costs for a server may be divided in a manner that weighs the burstiness of each workload on the server. This portion is represented in Equation 2.

$$Π \begin{matrix}server \text{-} burst \text{-} portion \\ s , w\end{matrix} = {C}_{s}^{d} \frac{{d}_{s , w}}{{\sum }_{{w}^{′} = 1}^{W} {d}_{s , {w}^{′ }}} + {C}_{s}^{b} \frac{ɛ + {b}_{s , w}}{{\sum }_{{w}^{′} = 1}^{W} ( ɛ + {b}_{s , {w}^{′}} )} \qquad EQUATION 2$$

Equation 2 includes the bursty portion of costs for a workload. The costs are represented as the sum for direct resource use costs and costs for workload burstiness. The costs for workload burstiness are represented as the costs for burstiness of the server, C^{b}ₛ, multiplied by the burstiness of the workload and divided by the sum of burstiness for all workloads.

The server's unallocated resources may then be apportioned based on the direct and bursty portion. Server-burst cost may be determined according to Equation 3.

$$Π \begin{matrix}server \text{-} burst \\ s , w\end{matrix} = Π \begin{matrix}server \text{-} burst \text{-} portion \\ s , w\end{matrix} + {C}_{s}^{a} \frac{Π \begin{matrix}server \text{-} burst \text{-} portion \\ s , w\end{matrix}}{{\sum }_{{w}^{′} = 1}^{W} Π \begin{matrix}server \text{-} burst \text{-} portion \\ s , w\end{matrix}} \qquad EQUATION 3$$

Equation 3 represents the total workload costs. The total workload costs include the direct use costs, burstiness costs and costs for unused capacity. The costs for unused capacity may be assigned on a per server basis, based on the portion of the costs of the workload for direct and burst resource use.

The ε value may be incorporated into the numerator and denominator of Equation 2 to help ensure that the denominator does not evaluate to zero for cases where there is no difference between peak and mean resource usage. According to Equation 2, total CPU costs for Workload A may be $54.70, and for Workload B, $21.70. The difference may stem from the fact that Workload A is much burstier than Workload B.

Typically, costs are also sensitive to the placement of workloads on servers. As such, using the server-burst approach may lead to a lack of robustness with regard to the impact of workload placement. Accordingly, an embodiment may use an approach that takes into account all the servers, S, in a resource pool, instead of each individual server. This approach is referred to herein as a pool-burst approach. Similar to the server-burst approach, a portion of the burstiness may be determined according to Equation 4.

$$Π \begin{matrix}pool \text{-} burst \text{-} portion \\ s , w\end{matrix} = {C}_{s}^{d} \frac{{d}_{s , w}}{{\sum }_{{w}^{′} = 1}^{W} {d}_{s , {w}^{′}}} + ( {\sum }_{{s}^{′} = 1}^{s} {C}_{{s}^{′}}^{b} ) \frac{ɛ + {b}_{s , w}}{{\sum }_{{s}^{′} = 1 , {w}^{′} = 1}^{S , W} ( ɛ + {b}_{{s}^{′} , {w}^{′}} )} \qquad EQUATION 4$$

Equation 4 represents the direct costs and burst costs for a workload. Burst costs may be assigned as the costs for burstiness multiplied by the burstiness of the workload and divided by the sum of burstiness of all workloads in the resource pool.

Using the pool-burst approach, the cost may be determined according to Equation 5.

$$Π \begin{matrix}pool \text{-} burst \\ s , w\end{matrix} = Π \begin{matrix}pool \text{-} burst \text{-} portion \\ s , w\end{matrix} + {\sum }_{{s}^{′} = 1}^{S} {C}_{{s}^{′}}^{a} \frac{Π \begin{matrix}pool \text{-} burst \text{-} portion \\ s , w\end{matrix}}{{\sum }_{{s}^{′} = 1 , {w}^{′} = 1}^{S , W} Π \begin{matrix}pool \text{-} burst \text{-} portion \\ {s}^{′} , {w}^{′}\end{matrix} } \qquad EQUATION 5$$

Equation 5 represents the total workload cost. The costs for unused capacity may be assigned on a per pool basis, based on the portion of workload costs for direct and burst resource pool use.

According to Equation 5, the total costs for Workload A are $62.20, and for Workload B, $23.00. Although this example makes specific reference to CPU costs, the pool-burst approach may be similarly applied to memory and other resource costs. In one embodiment, the individual resource costs may be summed to represent total costs for a workload.

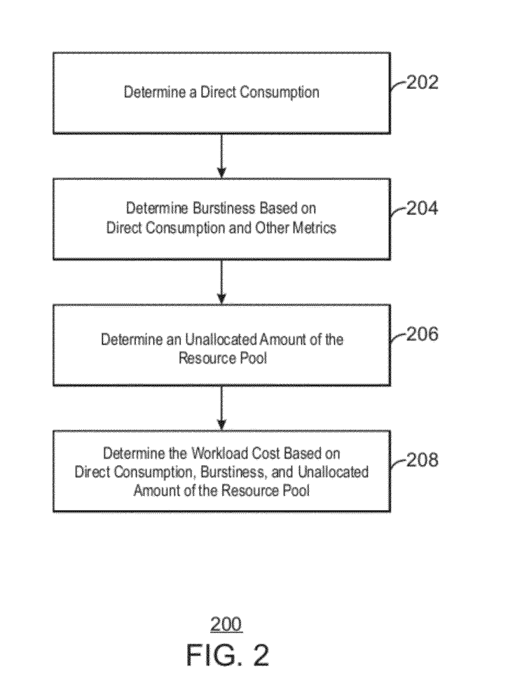

FIG. 2 is a process flow diagram showing a method 200 of determining workload cost in accordance with an embodiment. At block 202, direct consumption of a resource pool by a workload is determined. At block 204, burstiness is determined for the workload and the resource pool. Burstiness may be based on a difference between a peak consumption of the resource pool by the workload and the direct consumption of the resource pool.

At block 206, unallocated amount of the resource pool is determined. At block 208, the workload cost is determined based on the direct consumption, the burstiness, and the unallocated amount of the resource pool.

### Example

In this example, three months of workload trace data for 312 workloads was obtained. Each workload was hosted on its own server, therefore resource demand measurements for the server may be used to characterize each server's demand trace. The measurements were originally recorded using virtual memory statistics (VMSTAT) and system activity reports (SAR). Each trace describes resource usage, such as processor and memory demands, as measured every 5 minutes

CPU capacity and CPU demand may be described in units of CPU shares. A CPU share denotes one percentage of utilization of a processor with a clock rate of 1 GHz. A scale factor adjusts for the capacity between nodes with different processor speeds or architectures. For example, the nodes with 2.93 GHz CPUs were assigned 293 shares. Scaling factors were approximate, and memory usage was measured in gigabytes (GB).

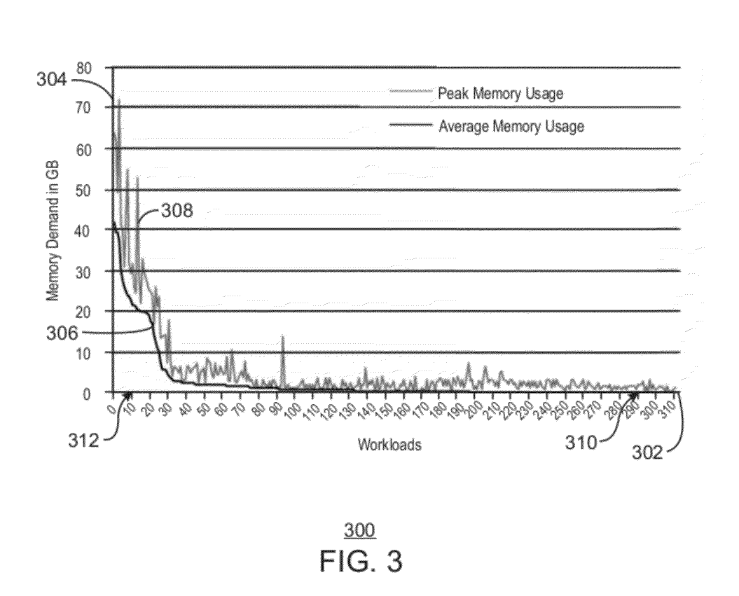

FIG. 3 is a graph 300 representing workload memory usage in accordance with an embodiment. The graph 300 includes an x-axis 302 representing the 312 workloads and a y-axis 304 representing memory demand in GB. Graph 300 also shows the average memory usage 306 and peak memory usage 308 for each workload. The workloads have been ordered by their average memory usage for presentation purposes. For example, workload 290, indicated by reference number 310, has a lower average memory usage when compared to workload 10, indicated by reference number 312. For 80% of the workloads, the average memory usage 306 was less than 2 GB. While the peak memory usage 308 and the average memory usage 306 were small and very close in absolute terms, the peak-to-mean ratios were still high enough that they may affect costs from the point of view of a service provider. For 10% of the workloads the peak memory usage was much higher, at approximately 10-70 GB. For these workloads, the peak memory usage 308 can be very large in absolute terms, but the peak-to-mean ratios were generally less than 3. Accordingly, workloads with a high memory usage generally had higher peak and average CPU usage.

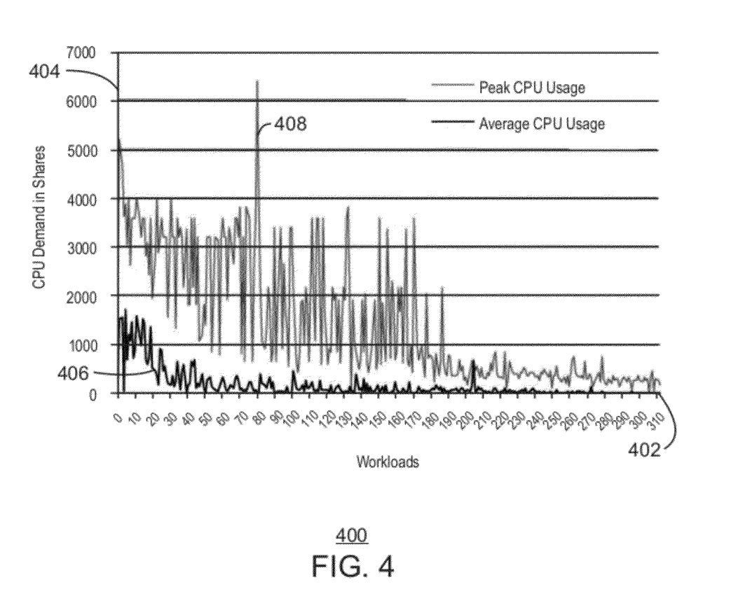

FIG. 4 is a graph 400 representing workload CPU usage in accordance with an embodiment. The graph 400 includes an x-axis 402 representing the 312 workloads and a y-axis 404 representing memory demand in GB. As indicated in FIGS. 3 and 4, the first 50 workloads had a higher average memory usage 306 (FIG. 3) and a higher average CPU usage 406 than the remaining workloads. Additionally, the workloads typically had very bursty CPU demands, as shown in FIG. 4. While most of the workloads in FIG. 4 had relatively low average CPU usage 406, their peak CPU usage 408 was rather high. The graph 400 shows 85% of the workloads had an average CPU usage at 406 of less than 293 CPU shares, and 42% of the workloads had a peak CPU usage 408 of more than 1000 CPU shares. As a result, the peak-to-mean ratio for CPU usage was 52.6, with some workloads having a peak-to-mean ratio above 1000.

Consolidation, as described herein, was accomplished through the use of a consolidation engine that minimized the number of servers needed to host the workloads while satisfying their time varying resource demand requirements. The engine was able to offer many solutions that were near-optimal. Consider a scenario in which a shared resource pool configuration included servers consisting of 24×2.93-GHz processor cores, 128 GB of memory, and two dual 10 GB/s Ethernet network interface cards for network traffic and virtualization management traffic, respectively. The total acquisition cost for each server was estimated as $58,000, including licensing costs. A breakdown of the total acquisition cost reveals the costs were approximately $31,000 for a unit of CPU shares and $27,000 for memory. Using linear depreciation and assuming a lifetime of three years, the cost for three weeks was $370.80 per server. Further, to evaluate the robustness, or repeatability, of costs assignments, consider 100 consolidation solutions for a three week costing interval. For the 100 consolidation solutions, the consolidation engine reported solutions that assigned the 312 workloads to between 18 and 20 physical servers in the resource pool causing the fine sharing of resources.

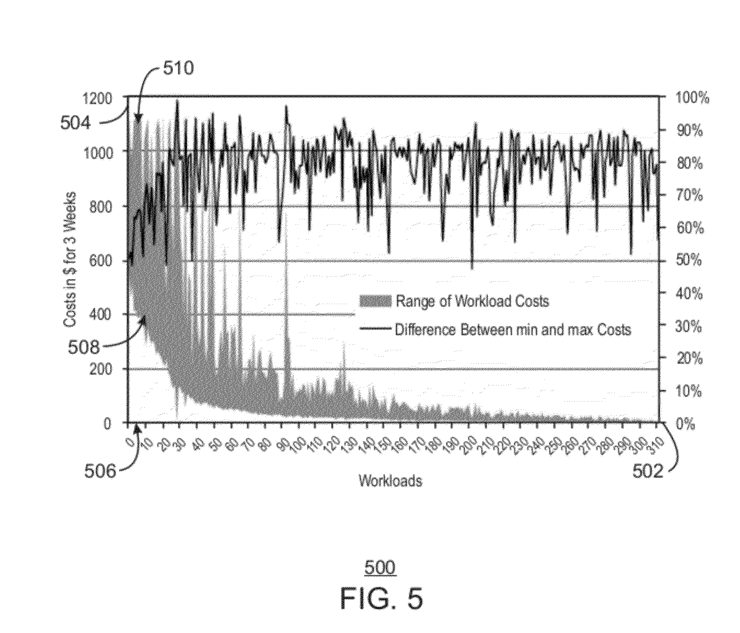

FIG. 5 is a graph 500 representing costs by server usage in accordance with an embodiment. The graph 500 includes an x-axis 502 representing the 312 workloads and a y-axis 504 representing the cost for three weeks in dollars. For example, workload 5, indicated by reference number 506, had a cost that ranged from approximately $400, indicated by reference number 508, to $1100, indicated by reference number 510, for the same work. Such a large range in dollar amount can make planning and charging customers for their workloads difficult.

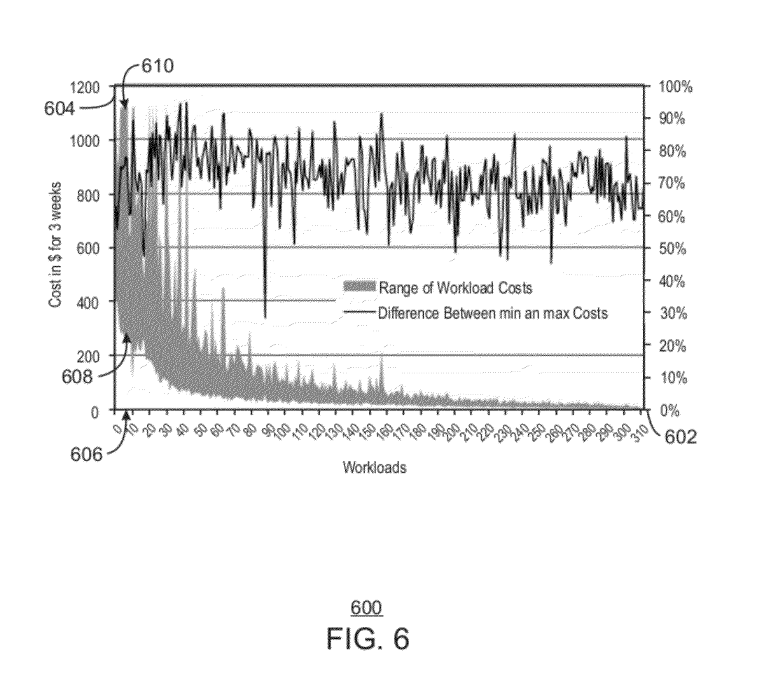

FIG. 6 is a graph representing costs by server burst in accordance with an embodiment. The graph 600 includes an x-axis 602 representing the 312 workloads and a y-axis 604 representing the cost for three weeks in dollars. Like the server usage approach in FIG. 5, the server burst approach had a wide range for the assigned costs for each workload. For example, workload 5, indicated by reference number 606, had a cost that could range from approximately $250, indicated by reference number 608, to $1100, indicated by reference number 610, for the same work.

Visual inspection showed that the server-usage approach in FIG. 5 and the server-burst approach in FIG. 6 had very wide ranges for the assigned costs. The average differences between minimum and maximum costs assigned to the workloads were 79% and 72%, respectively. Taking into account burstiness may decrease the variability in assigned costs, but does not yield robust cost assignments.

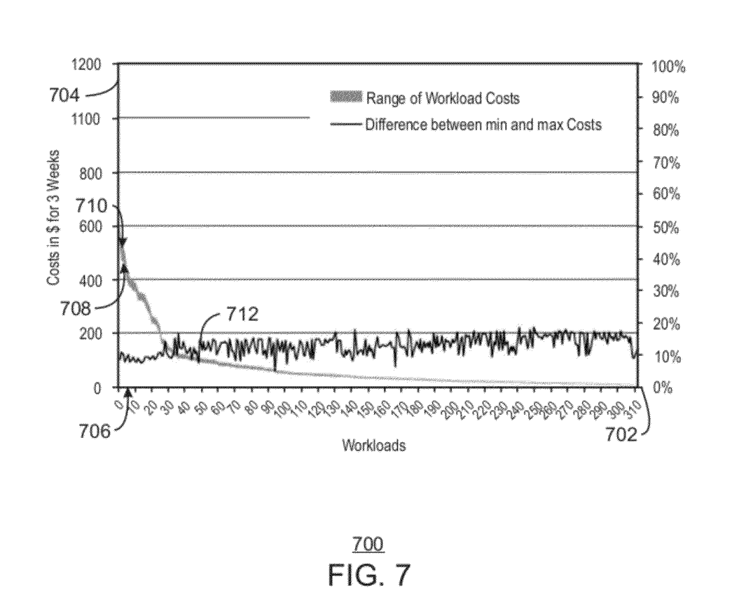

FIG. 7 is a graph 700 representing costs by pool burst usage in accordance with an embodiment. The graph 700 includes an x-axis 702 representing the 312 workloads and a y-axis 704 representing the cost for three weeks in dollars. The cost assignments of the pool burst approach in graph 700 were much less sensitive to workload placement decisions and had a much tighter range. For example, workload 5, indicated by reference number 706, had a cost that could range from approximately $450, indicated by reference number 708, to $735, indicated by reference number 710, for the same work. Additionally, the average difference between minimum and maximum costs 712 was reduced to 13%, which reflects the difference in consolidation to between 18 and 20 servers.

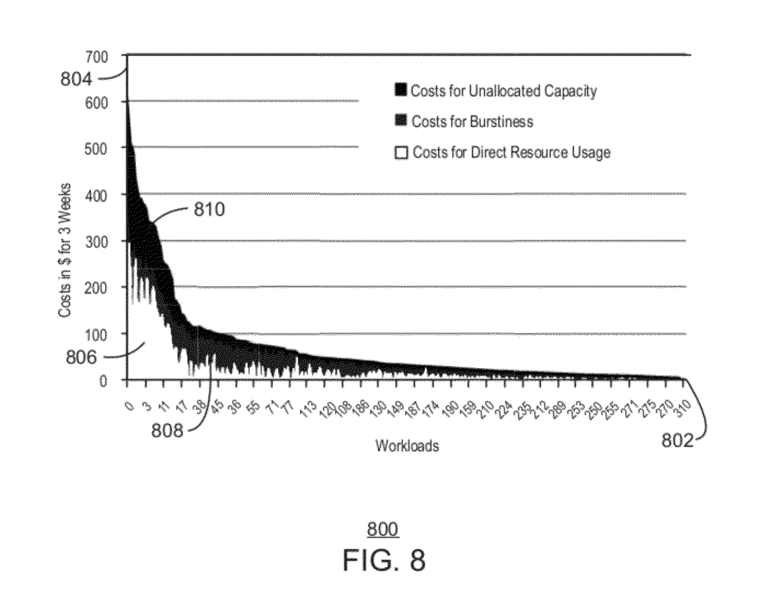

FIG. 8 is a graph 800 representing CPU and memory costs per workload in accordance with an embodiment. The graph 800 includes an x-axis 802 representing the 312 workloads and a y-axis 804 representing the cost for three weeks in dollars. The graph 800 shows a breakdown of the sum of CPU and memory costs over the 100 consolidation scenarios as apportioned by direct usage 806 according to d_{s,w}, bursty usage 808 according to b_{s,w}, and unallocated usage 810 as calculated using Equation (3). In graph 800, the workloads were sorted by total cost. For most workloads, most of the costs stemmed from direct usage 806 and burstiness 808. As defined by Equation (3), the relative costs for unallocated usage 810 were similar for all workloads. In this scenario, the unallocated usage 810 was almost entirely due to memory costs. Additionally, the ratio between costs for direct usage 806 and for burstiness 808 differed significantly between the workloads. This difference was due to the burstiness of the workloads differing significantly.

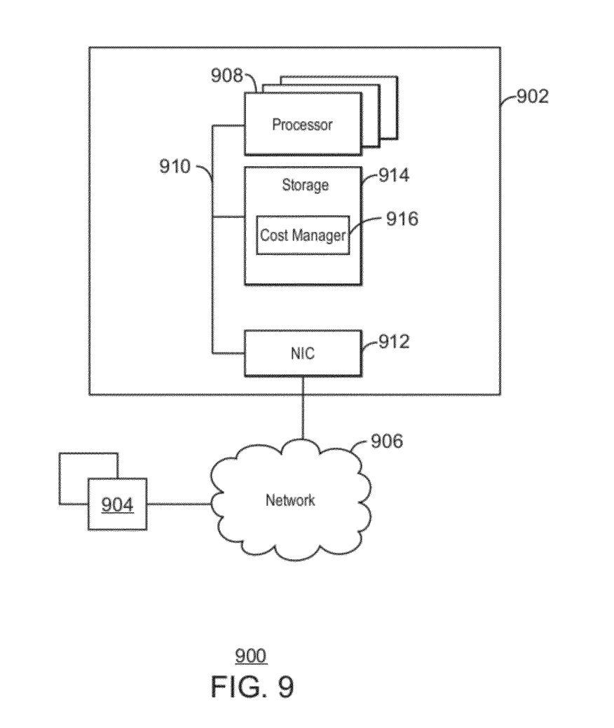

FIG. 9 is a block diagram of a system 900 for determining workload cost in accordance with an embodiment. The functional blocks and devices shown in FIG. 9 may comprise hardware elements, software elements, or some combination of software and hardware. The hardware elements may include circuitry. The software elements may include computer code stored on a non-transitory, computer-readable medium. Additionally, the functional blocks and devices of the system 900 are but one example of functional blocks and devices that may be implemented in an embodiment. Specific functional blocks may be defined based on design considerations for a particular electronic device.

The system 900 may include servers 902 in communication with, or otherwise coupled to a network 906. The servers 902 may include a processor 908, which may be connected through a bus 910 to a display, a keyboard, an input device, and an output device, such as a printer. Further, the input devices may include devices such as a mouse or touch screen. The servers 902 may also be connected through the bus 910 to a network interface card 912. The network interface card 912 may connect the servers 902 to the network 906.

The network 906 may be a local area network, a wide area network, such as the Internet, or another network configuration. The network 906 may include routers, switches, modems, or any other kind of interface device used for interconnection. In one example embodiment, the network 906 may be the Internet. The network 906 may connect to several client computers 904. Through the network 906, several client computers 904 may connect to the server 902. Further, the server 902 may access resources across network 906. The client computers 904 may be similarly structured as the server 902.

The servers 902 may have other units operatively coupled to the processor 908 through the bus 910. These units may include non-transitory, computer-readable storage media, such as storage 914. The storage 914 may include media for the long-term storage of operating software and data, such as hard drives. The storage 914 may also include other types of non-transitory, computer-readable media, such as read-only memory and random access memory. The memory may be in a shared memory space, accessible to all processors 908, in a dedicated memory space for each processor 908, or both.

The storage 914 may include the machine readable instructions used in embodiments of the present techniques. In an embodiment, the storage 914 may include a cost manager 916. The cost manager 916 may perform functionality described herein with respect to determining a cost of resource usage for a workload. Although the cost manager 916 is shown to reside on server 902, a person of ordinary skill in the art would appreciate that the cost manager 916 may reside on the server 902 or any of the client computers 904.

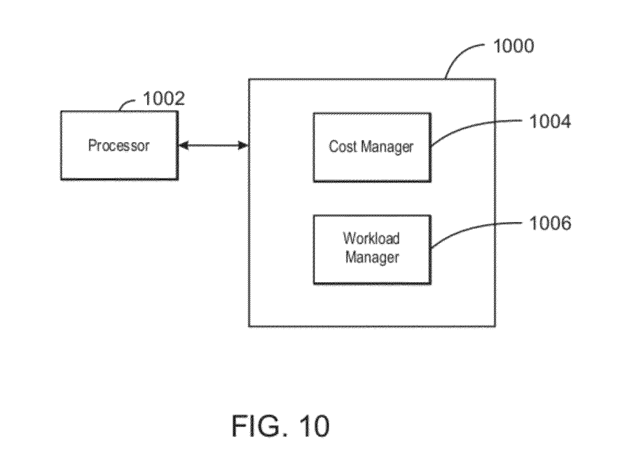

FIG. 10 is a block diagram showing a non-transitory, computer-readable medium that stores code for extracting concepts and relationships from texts. The non-transitory, computer-readable medium is generally referred to by the reference number 1000.

The non-transitory, computer-readable medium 1000 may correspond to any typical storage device that stores computer-implemented instructions, such as programming code or the like. For example, the non-transitory, computer-readable medium 1000 may include one or more of a non-volatile memory, a volatile memory, and/or one or more storage devices. The storage device may be, for example, the storage 922 discussed with respect to FIG. 9.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 1002 generally retrieves and executes the computer-implemented instructions stored in the non-transitory, computer-readable medium 1000 for extracting concepts and relationships from texts. At block 1004, a workload manager may determine direct consumption, burstiness, and an unallocated amount of the resource pool. At block 1006, a cost manager may determine a workload cost based on the direct consumption, burstiness, and an unallocated amount of the resource pool.

What is claimed is:

1. A method for determining a workload cost, the method comprising:
determining a direct consumption of a resource pool by a workload;
determining a burstiness for the workload and the resource pool, wherein the burstiness comprises a difference between a peak consumption of the resource pool by the workload, and the direct consumption of the resource pool;
determining an unallocated amount of the resource pool; and
determining the workload cost based on the direct consumption, the burstiness, and the unallocated amount of the resource pool.

2. The method recited in claim 1, comprising:
determining a second workload cost based on a direct consumption of a second resource pool by the workload, a burstiness for the second resource pool and the workload, and an unallocated amount of the second resource pool; and
summing the workload cost and the second workload cost to determine a total workload cost.

3. The method recited in claim 1, wherein the workload cost comprises costs for unused capacity assigned on a per pool basis, based on a portion of workload costs for direct and burst resource pool use, such that
$$Π \begin{matrix}pool \text{-} burst \\ s , w\end{matrix} = Π \begin{matrix}pool \text{-} burst \text{-} portion \\ s , w\end{matrix} + {\sum }_{{s}^{′} = 1}^{S} {C}_{{s}^{′}}^{a} \frac{Π \begin{matrix}pool \text{-} burst \text{-} portion \\ s , w \end{matrix}}{{\sum }_{{s}^{′} = 1 , {w}^{′} = 1}^{S , W} Π \begin{matrix}pool \text{-} burst \text{-} portion \\ {s}^{′} , {w}^{′}\end{matrix}} , wherein$$
$$Π \begin{matrix}pool \text{-} burst \text{-} portion \\ s , w\end{matrix} = {C}_{s}^{d} \frac{{d}_{s , w}}{{\sum }_{{w}^{′} = 1}^{W} {d}_{s , {w}^{′}}} + ( {\sum }_{{s}^{′} = 1}^{S} {C}_{{s}^{′}}^{b} ) \frac{ɛ + {b}_{s , w}}{{\sum }_{{s}^{′} = 1 , {w}^{′} = 1}^{S , W} ( ɛ + {b}_{{s}^{′} , {w}^{′}} )} , S$$
comprises a plurality of servers, C^{a}ₛ represents an unallocated amount of the resource pool on a server, s, and b_{s,w} represents a burstiness for the workload on server s.

4. The method recited in claim 1, wherein the direct consumption of the resource pool comprises an average percentage use of the resource pool by the workload.

5. The method recited in claim 1, wherein the unallocated amount of the resource pool comprises a difference between 100 percent and the direct consumption of the resource pool.

6. The method recited in claim 1, wherein the burstiness for the workload and the resource pool represents a percentage difference between the peak usage and the direct consumption of the resource pool, or wherein burstiness for the workload and the resource pool represents a difference between a high percentile of utilization of a server and its average utilization.

7. The method recited in claim 1, comprising determining a chargeback based on the workload cost.

8. A computer system for determining a workload cost, comprising:
a memory storing instructions;
a processor configured to execute the instructions to:
determine a direct consumption of a resource pool by a workload;
determine a burstiness for the workload and the resource pool,
wherein the burstiness comprises a difference between a peak consumption of the resource pool by the workload, and the direct consumption of the resource pool;
determine an unallocated amount of the resource pool; and
determine the workload cost based on the direct consumption, the burstiness, and the unallocated amount of the resource pool.

9. The system recited in claim 8, comprising:
determining a second workload cost based on a direct consumption of a second resource pool by the workload, a burstiness for the second resource pool and the workload, and an unallocated amount of the second resource pool; and
summing the workload cost and the second workload cost to determine a total workload cost.

10. The system recited in claim 8, wherein the workload cost comprises costs for unused capacity assigned on a per pool basis, based on a portion of workload costs for direct and burst resource pool use, such that
$$Π \begin{matrix}pool \text{-} burst \\ s , w\end{matrix} = Π \begin{matrix}pool \text{-} burst \text{-} portion \\ s , w\end{matrix} + {\sum }_{{s}^{′} = 1}^{S} {C}_{s}^{a} \frac{Π \begin{matrix}pool \text{-} burst \text{-} portion \\ s , w\end{matrix}}{{\sum }_{{s}^{′} = 1 , {w}^{′} = 1}^{S , W} Π \begin{matrix}pool \text{-} burst \text{-} portion \\ {s}^{′} , {w}^{′ }\end{matrix}} , wherein$$
$$Π \begin{matrix}pool \text{-} burst \text{-} portion \\ s , w\end{matrix} = {C}_{s}^{d} \frac{{d}_{s , w}}{{\sum }_{{w}^{′} = 1}^{W} {d}_{s , {w}^{′}}} + ( {\sum }_{{s}^{′} = 1}^{S} {C}_{{s}^{′}}^{b} ) \frac{ɛ + {b}_{s , w}}{{\sum }_{{s}^{′} = 1 , {w}^{′} = 1}^{S , W} ( ɛ + {b}_{{s}^{′} , {w}^{′}} )} , S$$
comprises a plurality of servers, C^{a}ₛ represents an unallocated amount of the resource pool on a server, s, and b_{s,w} represents a burstiness for the workload on server s.

11. The system recited in claim 8, wherein the direct consumption of the resource pool comprises an average percentage use of the resource pool by the workload.

12. The system recited in claim 8, wherein the unallocated amount of the resource pool comprises a difference between 100 percent and the direct consumption of the resource pool.

13. The system recited in claim 8, wherein the burstiness for the workload and the resource pool represents a percentage difference between the peak usage and the direct consumption of the resource pool, or wherein burstiness for the workload and the resource pool represents a difference between a high percentile of utilization of a server and its average utilization.

14. The system recited in claim 8, comprising determining a chargeback based on the workload cost.

15. A non-transitory, computer-readable medium comprising machine-readable instructions executable by a processor to:
determine a direct consumption of a resource pool by a workload;
determine a burstiness for the workload and the resource pool, wherein the burstiness comprises a difference between a peak consumption of the resource pool by the workload, and the direct consumption of the resource pool;
determine an unallocated amount of the resource pool; and
determine the workload cost based on the direct consumption, the burstiness, and the unallocated amount of the resource pool.

16. The non-transitory, computer-readable medium recited in claim 15, comprising:
determining a second workload cost based on a direct consumption of a second resource pool by the workload, a burstiness for the second resource pool and the workload, and an unallocated amount of the second resource pool; and
summing the workload cost and the second workload cost to determine a total workload cost.

17. The non-transitory, computer-readable medium recited in claim 15, wherein the workload cost comprises costs for unused capacity assigned on a per pool basis, based on a portion of workload costs for direct and burst resource pool use, such that
$$Π \begin{matrix}pool \text{-} burst \\ s , w\end{matrix} = Π \begin{matrix}pool \text{-} burst \text{-} portion \\ s , w\end{matrix} + {\sum }_{{s}^{′} = 1}^{S} {C}_{{s}^{′}}^{a} \frac{Π \begin{matrix}pool \text{-} burst \text{-} portion \\ s , w\end{matrix}}{{\sum }_{{s}^{′} = 1 , {w}^{′} = 1}^{S , W} Π \begin{matrix}pool \text{-} burst \text{-} portion \\ {s}^{′} , {w}^{′}\end{matrix}} , wherein$$
$$Π \begin{matrix}pool \text{-} burst \text{-} portion \\ s , w\end{matrix} = {C}_{s}^{d} \frac{{d}_{s , w}}{{\sum }_{{w}^{′} = 1}^{W} {d}_{s , {w}^{′}}} + ( {\sum }_{{s}^{′} = 1}^{S} {C}_{{s}^{′}}^{b} ) \frac{ɛ + {b}_{s , w}}{{\sum }_{{s}^{′} = 1 , {w}^{′} = 1}^{S , W} ( ɛ + {b}_{{s}^{′} , {w}^{′}} )} , S$$
comprises a plurality of servers, C^{a}ₛ represents an unallocated amount of the resource pool on a server, s, and b_{s,w} represents a burstiness for the workload on server s.

18. The non-transitory, computer-readable medium recited in claim 15, wherein the direct consumption of the resource pool comprises an average percentage use of the resource pool by the workload.

19. The non-transitory, computer-readable medium recited in claim 15, wherein the unallocated amount of the resource pool comprises a difference between 100 percent and the direct consumption of the resource pool.

20. The non-transitory, computer-readable medium recited in claim 15, wherein the burstiness for the workload and the resource pool represents a percentage difference between the peak usage and the direct consumption of the resource pool, or wherein burstiness for the workload and the resource pool represents a difference between a high percentile of utilization of a server and its average utilization.
